(19) United States
(12) Patent Application Publication
(10) Pub. No.: US 2011/0256762 A1
(43) Pub. Date: Oct. 20, 2011

(54) CONNECTOR ASSEMBLY WITH CONTACT PROTECTION FUNCTION

(76) Inventors: Ludwig Lange, Nuland (NL); Thierry Goossens, Herdersem-Aalst (BE)

(21) Appl. No.: 12/998,594

(22) PCT Filed: Nov. 6, 2008
(86) PCT No.: PCT/IB2008/055636

§ 371 Date: Jun. 23, 2011

(51) Int. Cl. H01R 13/648

(52) U.S. Cl. 439/607.01

(57) ABSTRACT

The present invention provides a connector assembly including a first connector and a corresponding second connector adapted to be mated with the first connector along a mating direction to a mating position. The first connector includes at least a first terminal arranged within the first insulating housing and a first contact member protruding from a shield in the mating direction and being arranged on an external side of the first mating portion. The second connector includes a second terminal arranged within a second insulating housing and a second contact member arranged at least partially within the second mating portion for making contact with the first contact member of the first connector. The first and second contact members establish a first make, last break contact.

### RELATED FIELD

The present invention relates to the field of connectors, more in particular connectors providing electrostatic discharge protection.

### BACKGROUND

When two objects or devices are to be electrically connected by connectors of a connector assembly, it is often found that the contacts to be connected, in particular the contacts which should be at the respective “ground” potentials of both connectors or devices, are at different voltages. Such voltage differences may be due to charging by static electricity or by pick up of stray electric fields. The latter process is enhanced in case one of the connected devices comprises an elongated portion, e.g. a shielded cable, which may function as an aerial. The mutual voltage differences which are built up may rise to hundreds of volts and even amount to several kilovolts.

Upon connection, the devices at different voltages will discharge to bring both devices to the same potential, cancelling the voltage difference. Voltage and/or current spikes caused by such discharges may harm connected sensitive electronic devices. It should be prevented. In addition, the discharges may be accompanied by sparks, which may cause damage to contact surfaces and which may produce noise on nearby signals. These effects should also be prevented.

A connector assembly, allowing controlled discharging of devices to be connected at a reduced risk of damaging (one or more portions of) the devices, and in which the electrostatic discharge (ESD) means is less prone to be damaged and is less expensive and/or difficult to manufacture is therefore desired.

### SUMMARY

To address at least part of the aforementioned desire a connector assembly according to claim 1 is provided.

With an appropriate arrangement of the terminals and contact members, the first and second connectors are configured so as to form a so-called first make, last break contact. Voltage differences between the devices to be connected by the connector assembly will be cancelled by the contact between the contact members prior to establishing contact between the terminals. This serves to protect the terminals and associated sensitive electronic devices.

The first contact member may extend from the shield. Then it ensures that contact is initially made to the shield of the device to be contacted. A shield is generally at the ground potential of a device to be contacted and it thus provides a proper contact point for discharging the devices and cancelling mutual voltage differences.

The first contact member extending from the shield also allows reducing the amount of shielding material since the shield need not extend over and/or envelop the first mating portion. This reduces material costs of the first connector. It further allows a relatively small size of the first connector, keeping up with the ongoing trend for miniaturization of electric devices and connectors.

The second contact member being arranged within the second mating portion allows a relatively small and compact second connector, in line with the miniaturization trend. It further provides electrical and mechanical insulation of the second contact member, improving the connector reliability and robustness.

The terminals may be signal terminals and may be connected to relatively sensitive equipment. The first and second connectors may comprise a plurality of terminals.

In at least one of the first and second connectors, the first and second contact members may extend along the mating direction further than the first and second terminals. This assists ensuring that a contact is initially made between the first and second contact members.

The first and second connectors may be any type of connector. Advantageously, the first connector is a cable connector and the second connector is a board connector.

In case the cable connector shield is a conductive cable braid the shield may extend along the entire cable. A cable shield may become charged from acting as an aerial and the connector assembly allows dedicated discharging of the cable shield. When the cable shield is or is not directly connected to the potential of the terminal to be connected, a harmful discharge may be prevented.

When the contact member(s) is (are) provided as a separate part(s), the embodiment provides a substantially modular first connector which may be assembled with relatively little effort. The contact member may comprise a different material from the shield. E.g., the shield may be manufactured of a material which may efficiently be formed in a relatively complex shape such as a die cast metal, whereas the contact member comprises a metal sheet material with an elevated spark erosion resistance or with a desired resiliency.

When the contact member(s) is (are) embedded in the insulation portion(s) as a separate part(s), the embodiment provides protection from mechanical effects for the first contact member. This improves robustness of the first and/or second connector(s). The enveloped portion(s) of the first contact member is (are) also electrically protected from the environment of the first connector.

An embodiment with a conductive body as described below allows discharging the device comprising or connected to the first connector to a relatively large capacitance. This mitigates the effects of a possible voltage spike on the device.

When the conductive body is configured for contacting a printed circuit board and a construction of a device, this ensures that the shield of the first connector is at the same potential as a printed circuit board to which the second connector is connected and the construction of a device in which the second connector is mounted. The construction portion may be a wall portion, a chassis portion or a device frame or the like.

The conductive body may also serve for enhancing mechanical stability of the interconnected parts.

The first connector provides shielding and a well-defined and an accessible portion for contacting the shield to a second connector for establishing a first-make-last-break electrical contact.

A further aspect is a mounting bracket. The mounting bracket provides the mechanical functionality of attaching a connector and at least two further objects, enhancing robustness of a device comprising the connector and mounting bracket. The mounting bracket combines the mechanical effect with the functionality of electrically interconnecting the parts and providing a contact portion for connection with another connector. This is advantageous for providing a relatively large capacitance for cancelling voltage differences of devices to be connected while at different potentials. One or more voltage spikes due to a resulting discharge are therefore reduced. The mounting bracket may further provide shielding for the connector.

### BRIEF DESCRIPTION OF THE DRAWINGS

The invention will hereafter be explained in more detail with reference to the drawings showing an embodiment of the invention by way of example. In the drawings:

FIG. 1 is a perspective view of a connector assembly comprising a plug connector and a receptacle connector in a mated situation;

FIG. 2 is a perspective view of the plug connector of FIG. 1;

FIG. 3A is a detail of the plug connector of FIGS. 1-2, with a shield portion removed;

FIG. 3B is a detail similar to FIG. 3B of another embodiment;

FIGS. 4A-4C are various perspective views of the receptacle connector of FIG. 1;

FIG. 5 is a perspective view of a mounting bracket of the embodiment of FIGS. 4A-4C.

### DETAILED DESCRIPTION OF EMBODIMENTS

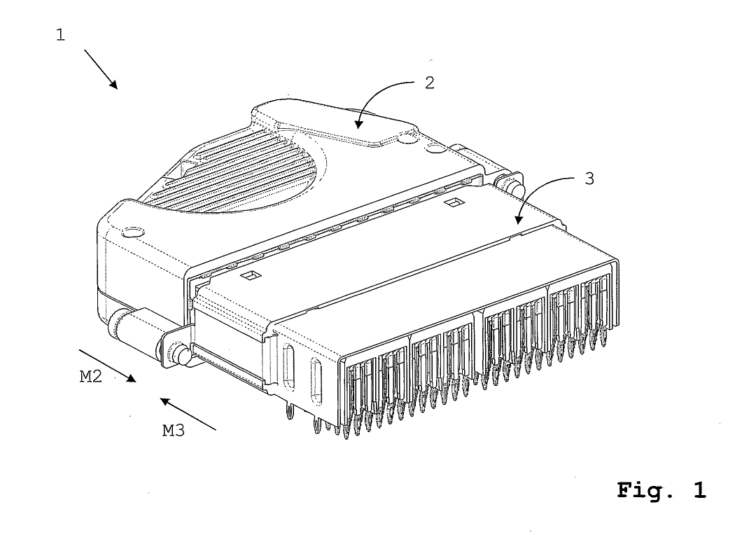

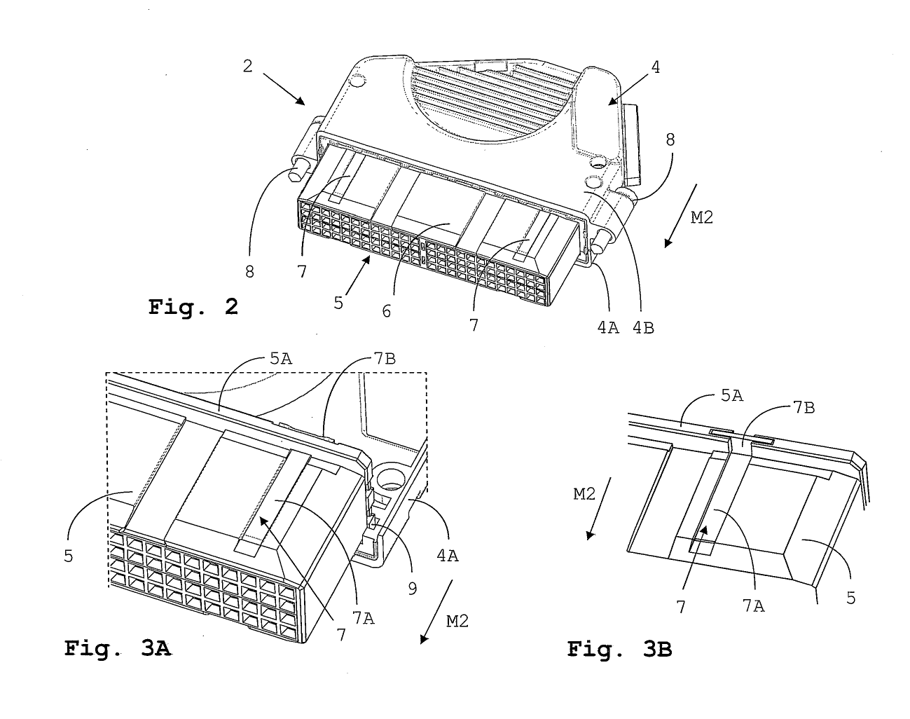

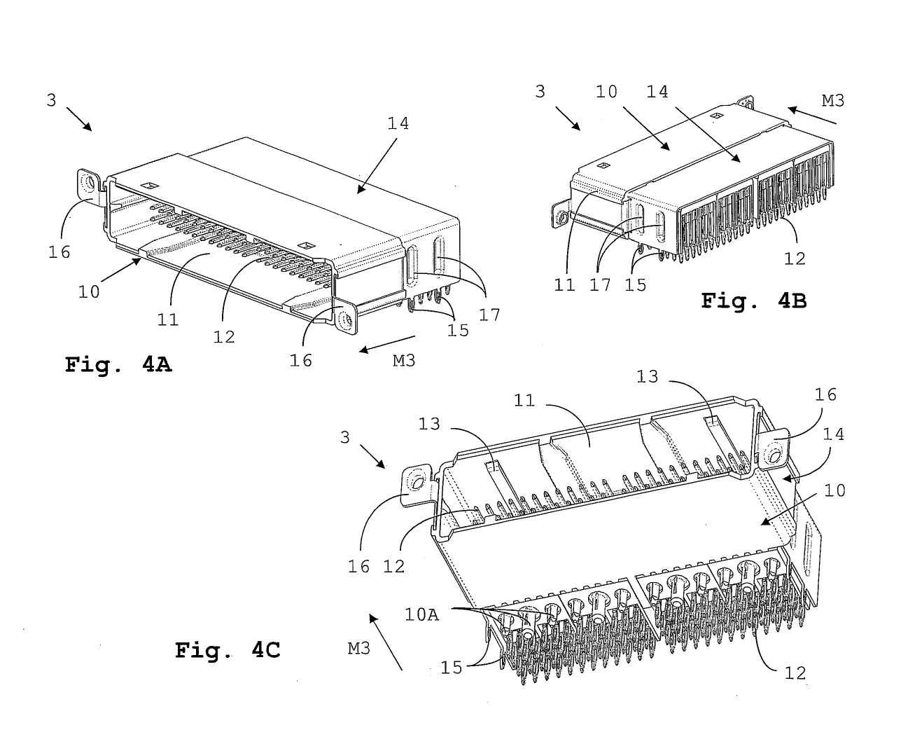

FIG. 1 shows a connector assembly 1 comprising a plug connector 2 and a corresponding receptacle connector 3. The connectors 2, 3 are adapted to be mated with each other along respective mating directions M2 and M3 to the mating position shown. In the shown embodiment the plug connector 2 is a cable connector and the receptacle connector 3 is a board connector. The cable connector 2 is shown in more detail in FIGS. 2-3 and the board connector is shown in more detail in FIGS. 4A-4C.

FIGS. 1-3 show that the plug connector 2 comprises a shield 4, an insulating housing 5 providing a first mating portion 6 extending from the shield 4 in the mating direction M2 and a number of terminals (not visible) arranged within the insulating housing 5. The shield 4 comprises two conductive shield members 4A, 4B which may comprise means for connection with a cable shield, e.g. a braid, of a shielded cable (not shown). The cable connector 2 further comprises two contact members 7 protruding from the shield 4 in the mating direction M2 and being arranged on an external side of the mating portion 6. The connector 2 is provided with means 8, here being screws, for fastening the connector 2 to a further object. The contact members 7 may be an integral part of the shield 4. However, they may also be a separate object as shown in FIGS. 3A and 3B, for facilitating assembly of the connector 2 and/or facilitating repairing or changing the contact member 7.

FIG. 3A shows a detail of the plug connector 2 with the shield member 4B removed. From FIG. 3A, it is visible that the insulating housing 5 comprises a flange 5A which is received in a groove 9 in the shield members 4A and 4B. The contact members 7 comprise a portion 7A which penetrates through an opening in the flange 5A in the mating direction M2, and a bent portion 7B which abuts the flange 5A. The combined thickness of the flange 5A and the portion 7B is more than the width of the groove 9, such that the contact member 7 is tightly and snugly clamped in the groove 9, providing both a mechanical fixture and an electrical contact between the shield 4 and the contact members 7.

FIG. 3B shows a detail of another embodiment, illustrating a portion of the insulating housing 5 and a contact member 7. In this embodiment the portion 7B is received within the flange 5A. The portion 7B may be contacted by one or more appropriately formed portions on side walls of the groove 9. Also, the portion 7B may extend from the flange 5A, for contacting the shield at the bottom of the groove 9.

The portions 7A of the contact members 7 are embedded in the insulating housing 5, protecting them from sideways forces. The portion 7A of the contact members 7 may have a general dove-tail cross-sectional shape in a direction substantially perpendicular to the mating direction M2 for securing the portion 7A within the housing 5.

On FIGS. 1 and 4A-4C, it is shown that the receptacle connector 3 is configured for being mounted to a printed circuit board (not shown) and that it comprises an insulating housing 10 providing a mating portion 11 extending in the mating direction M3 and a number of terminals 12 arranged within the insulating housing 10. In the shown embodiment the board connector 3 is a right angle connector wherein male terminals 12 extend in the mating direction M3 within the mating portion 11 and wherein the terminals 12 protrude from a bottom side of the insulating housing 10 for mounting the receptacle connector on a printed circuit board (see FIGS. 4B-4C). The insulating housing 10 further comprises posts 10A for mounting the receptacle connector on a printed circuit board. Other mounting means may equally be provided. The receptacle connector 3 further comprises two contact members 13 extending in the mating direction M3 which are arranged partially within the mating portion 11 for making contact with the contact members 7 of the plug connector 2.

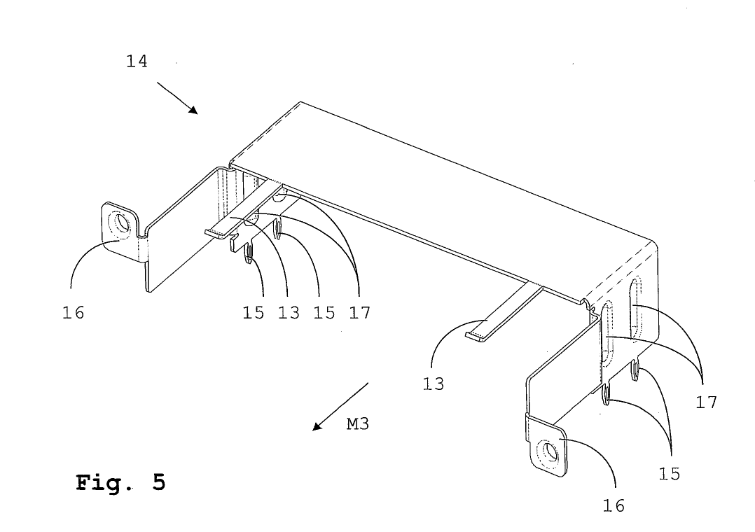

The receptacle connector 2 comprises a mounting bracket 14, which is shown in more detail in FIG. 5. The mounting bracket 14 is a conductive body which comprises the contact members 13. As may be seen from the Figures, a portion of the bracket 14 is arranged on an exterior side of a portion of the connector 3, with the contact members 13 penetrating through the insulating housing 10 and extending in the mating direction M3 within the mating portion 11 of the connector 3. The bracket 14 does not cover the mating portion 11, thus maintaining, on the mating portion, the exterior dimensions of the connector 3 at those of the housing 10. However, for providing or enhancing shielding for the connector 3, the bracket 14 may cover substantially the entire insulating housing 10 of the connector 3.

The mounting bracket 14 comprises eye-of-the-needle board mounting tails 15 for contacting a first object, e.g. a printed circuit board (not shown), and it is provided with means 16, here being screw ears, for mounting the connector 3 to a second object, e.g. a construction portion of a device, e.g. a front panel or a chassis portion of an electronic apparatus (not shown). Since the bracket 14 is conductive, the contact members may be mechanically and electrically connected to the two objects with a relatively large conductive surface area, hence a low resistance. The mounting bracket 14 thus may serve for ensuring grounding and shielding substantive portions of a device and its connections.

The mounting bracket 14 further comprises means, here dents 17, for attachment to the insulating housing 10. However, other ways of attaching the mounting bracket 14 and the insulating housing 10 together may also be used, such as riveting, screwing, injection molding, gluing etc. The mounting bracket 14 may comprise means for mounting to one or more further objects.

The bracket may be formed as a unitary body, e.g. by die casting or by stamping and forming a sheet of conductive material such as a metal sheet and more particularly such as sheet metal.

In at least one of the connectors 2, 3, preferably in both connectors 2,3, the respective contact members 7, 13 extend in the respective mating directions M2, M3, further than the terminals of that connector 2, 3. While mating the connectors 2 and 3, an electrical contact is established between the contact members 7 and 13 prior to establishing electrical contact between the terminals. During unmating of the connectors 2, 3 the electrical contact is broken between the contact members 7 and 13 after electrical contact between the terminals of the connectors 2, 3 has been broken. This provides protection against electrostatic discharge in the terminals, as explained above. A discharge current in the contact members 13 will be distributed over the entire mounting bracket and a plurality of contact points, thereby reducing possible adverse effects such as damaged contact points and/or leads in a connector and/or on a printed circuit board. The bracket 14 being formed to envelop a volume, here at least a portion of the connector 3, provides a Faraday cage-effect to the enveloped volume which may further protect one or more objects within the enveloped volume.

The portions of the contact members 7 and 13 on which the initial contact between them is to be made may especially be configured for withstanding spark erosion, e.g. by coating and/or manufacturing the contact member with a material which is particularly resistant to such erosion.

By arranging the contact members 7, 13 within the mating portion (or volume) 11 of the receptacle connector 3 any occurring arc is isolated from the environment. In particular when the mating portions 6, 11 are formed to substantially closely envelop each other, this may further enhance safety and it may reduce the possibility of fire hazard. The insulating housings 5, 10 of one or both connectors may comprise a fire extinguishing and/or flame retardant material.

The invention is not restricted to the above described embodiments which can be varied in a number of ways within the scope of the claims. For instance, the contact members 13 may be separately connected to the bracket 14.

The concepts explained in the foregoing may be realised with different connectors than a cable connector and a board connector, e.g. the connectors may be different type connectors, such as two matable cable connectors or two board connectors.

1. Connector assembly comprising a first connector and a corresponding second connector adapted to be mated with the first connector along a mating direction (M2, M3) to a mating position;
the first connector comprising a shield, a first insulating housing providing a first mating portion extending from the shield in the mating direction (M2) and at least a first terminal arranged within the first insulating housing,
the second connector comprising a second insulating housing providing a second mating portion extending in the mating direction (M3) and at least a second terminal arranged within the second insulating housing;
the first and second mating portions being configured such that in the mating position the first mating portion is received in the second mating portion,
wherein the first connector comprises a first contact member electrically connected to the shield and extending in the mating direction and being arranged on an external side of the first mating portion
wherein the second connector comprises a second contact member arranged at least partially within the second mating portion for making contact with the first contact member of the first connector.

2. Connector assembly according to claim 1, wherein the first and second terminals and the first and second contact members are arranged such that during mating of the first and second connectors an electrical contact is established between the first and second contact members prior to establishing electrical contact between the terminals, and/or
such that during unmating of the first and second connectors an electrical contact is broken between the first and second contact members after electrical contact between the first and second terminals has been broken.

3. Connector assembly according to claim 1, wherein the first contact member is a separate part supported by the first insulating housing and electrically connected to the shield.

4. Connector assembly according to claim 1, wherein the first contact member is partially embedded in the insulating material of the mating portion.

5. Connector assembly according to claim 1, wherein at least the second connector is a board connector comprising a conductive body configured for contacting at least two further objects and wherein the second contact member extends from the conductive body.

6. First connector for an assembly according to claim 1, comprising a shield, an insulating housing providing a mating portion extending in a mating direction (M2) for mating with a second connector and at least a contact terminal arranged within the insulating housing,
further comprising a contact member protruding from the shield along the mating direction and being arranged at an external side of the mating portion.

7. First connector according to claim 8, wherein the contact member is a separate part which is supported by the insulating housing and electrically connected to the shield.

8. First connector according to claim 6, wherein the contact member is partially embedded in the insulating material of the mating portion.

9. Second connector for an assembly according to claim 1, comprising an insulating housing providing a mating portion extending in a mating direction (M3) for mating with a first connector, at least a contact terminal arranged within the insulating housing and extending at least partially in the mating portion, and further comprising a second contact member arranged at least partially within the second mating portion for making contact with a first contact member of the first connector.

10. Second connector according to claim 9, further comprising a conductive body, the second contact member extending from the conductive body.

11. Mounting bracket for a second connector according to claim 9, having an insulating housing and a terminal mounted within the insulating housing,
the mounting bracket being electrically conductive and comprising a first portion for mounting on at least a first object, a second portion for mounting on a second object and further comprising a portion extending into the insulating housing for making contact with a contact member of a counterpart connector adapted to mate with the second connector.

12. Connector assembly comprising a cable connector and a corresponding board connector adapted to mate along a mating direction (M2; M3) to a mating position;
the cable connector comprising a shield connected to a cable shield, a first insulating housing providing a first mating portion extending from the shield in the mating direction (M2) and at least a first terminal arranged within the first insulating housing,
the board connector comprising a conductive body configured for contacting at least two further objects, a second insulating housing providing a second mating portion extending in the mating direction (M3) and at least a second terminal arranged within the second insulating housing;
the first and second mating portions being configured such that in the mating position the first mating portion is received in the second mating portion,
wherein the cable connector comprises a first contact member electrically connected to the shield, extending in the mating direction and being arranged on an external side of the first mating portion
wherein the board connector comprises a second contact member electrically connected to the conductive body and extending at least partially within the second mating portion for making contact with the first contact member of the cable connector, and
wherein the first and second terminals and the first and second contact members are arranged such that during mating of the connectors an electrical contact is established between the first and second contact members prior to establishing electrical contact between the terminals, and/or
such that during unmating of the connectors an electrical contact is broken between the first and second contact members after electrical contact between the first and second terminals has been broken.
